(19) United States
(12) Patent Application Publication
(10) Pub. No.: US 2009/0212855 A1
(43) Pub. Date: Aug. 27, 2009

(54) FEEDBACK TECHNIQUE AND FILTER AND METHOD

(76) Inventor: Jamaal Mitchell, Mountain View, CA (US)

Correspondence Address: DORSEY & WHITNEY LLP;INTELLECTUAL PROPERTY DEPARTMENT, SUITE 3400, 1420 FIFTH AVENUE, SEATTLE, WA, 98101, US

(21) Appl. No.: 12/390,251

(22) Filed: Feb. 20, 2009

Related U.S. Application Data
(60) Provisional application No. 61/066,641, filed on Feb. 22, 2008.

(51) Int. Cl. H04B 1/10

(52) U.S. Cl. 327/552

(57) ABSTRACT

An example filter includes a differential amplifier and a resistor string coupled between output terminals of the differential amplifier. The resistor string may generate a common mode sense voltage and an intermediate voltage at an intermediate node. A feedback resistor is coupled between the intermediate node of the resistor string and an input terminal of the differential amplifier, and a feedback capacitor is coupled between a differential output terminal of the amplifier and the differential input terminal. Applying feedback in this manner may reduce area and power requirements of the filter to achieve selected frequency and gain performance.

### CROSS-REFERENCE TO RELATED APPLICATION(S)

This application claims the benefit of the filing date of U.S. Provisional Application 61/066,641, entitled “Novel feedback method to reduce area and power in continuous-time filters,” filed Feb. 22, 2008, which application is hereby incorporated by reference in its entirety.

### BACKGROUND

Continuous time filters may be used in a variety of analog circuit applications. For example, many communications systems employ continuous time filters to filter out signal components above or below a frequency of interest, or otherwise modify the amplitude of a signal at a particular frequency or frequency range. DC components and high frequency noise may be filtered out, for example.

A general example of a traditional bandpass filter 20 utilizing a differential amplifier is shown in FIG. 1A. A differential input signal including signals In⁺ 10 and In⁻ 11 is applied to the inputs of the differential amplifier 30. Input capacitors 25 and 26 are positioned between the differential input signal and the inputs of the differential amplifier 30. The differential amplifier 30 generates a differential output signal including Out⁺ 50 and Out⁻ 51. Capacitive feedback from the output of the differential amplifier 30 to the input is provided by feedback capacitors 35 and 36 having values C_{fb}. Resistive feedback is also provided from the output of the differential amplifier 30 to the input by feed-back resistors 40 and 41 having values R_{fb}.

A schematic graph of the frequency characteristics of the filter 20 is shown in FIG. 1B, illustrating the gain across different frequencies of the amplifier. The slope of the gain changes at two frequencies, f₀ and f₁, as shown. The frequency f₀ is generally related to C_{fb} and R_{fb} and f₁ is generally related to the natural roll-off of the amplifier. The input and feedback capacitance may be used to set the overall filter gain. In this manner, the bandpass filter 20 generally amplifies signal components having frequencies between f₀ and f₁, while providing less amplification at, or attenuating, other frequencies.

### BRIEF DESCRIPTION OF THE DRAWINGS

FIG. 1A is a schematic diagram of a filter.

FIG. 1B is a schematic illustration of a frequency response of the filter of FIG. 1A.

FIG. 2 is a schematic diagram of a filter.

FIG. 3 is a schematic diagram of a filter.

FIG. 4 is a schematic diagram of a system including a filter.

### DETAILED DESCRIPTION

Certain details are set forth below to provide a sufficient understanding of embodiments of the invention. However, it will be clear to one skilled in the art that embodiments of the invention may be practiced without various of these particular details. Also, in some instances, well-known circuits, control signals, timing protocols, system blocks and software operations have not been shown in detail in order to avoid unnecessarily obscuring the described embodiments of the invention.

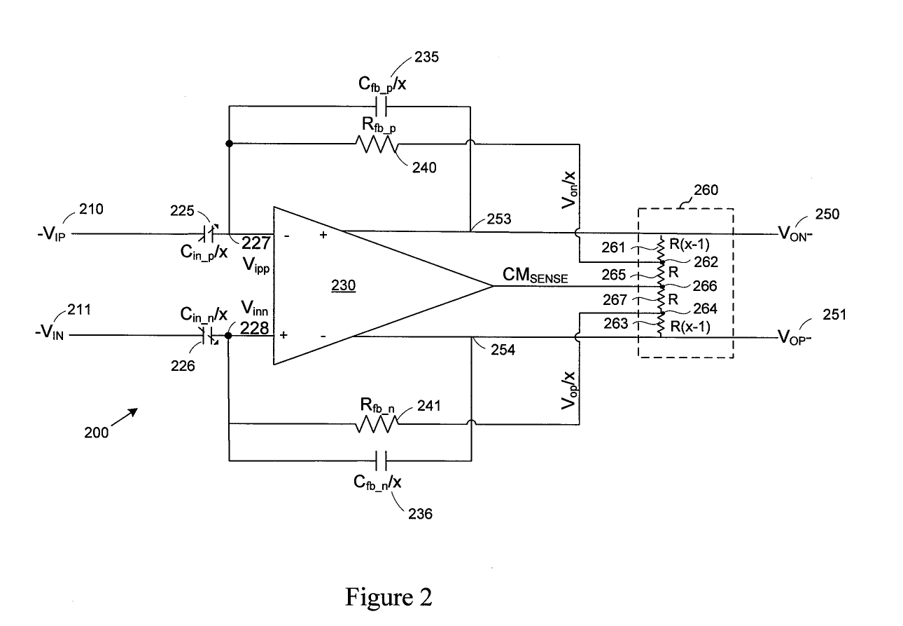

FIG. 2 is a schematic illustration of a filter 200 employing negative feedback. The filter includes a differential amplifier 230 having input nodes 227, labeled Vᵢₚₚ in FIG. 2, and 228, labeled Vᵢₙₙ in FIG. 2. The differential amplifier 230 generates a differential output signal including the signals V_{ON} 250 and V_{OP} 251 at output nodes 253 and 254, respectively.

A resistor string 260 is coupled between the differential output signals 250 and 251. The resistor string 260 includes a plurality of resistive elements 261, 265, 267, and 263. Although four resistive elements are shown in FIG. 2, generally any number may be used having substantially any value. The resistor string 260 may be used to provide common mode sense in a separate common mode feedback loop to the differential amplifier 230. That is, a voltage from a node 266 at a midpoint of the resistor string 260, CM_{SENSE} in FIG. 2, may be fed back through the differential amplifier 230. Details of the common mode feedback circuit are not shown in FIG. 2 for simplicity. Any type of common mode feedback may generally be used; in the FIG. 2 example, the resistor string 260 is used to generate a common mode feedback voltage.

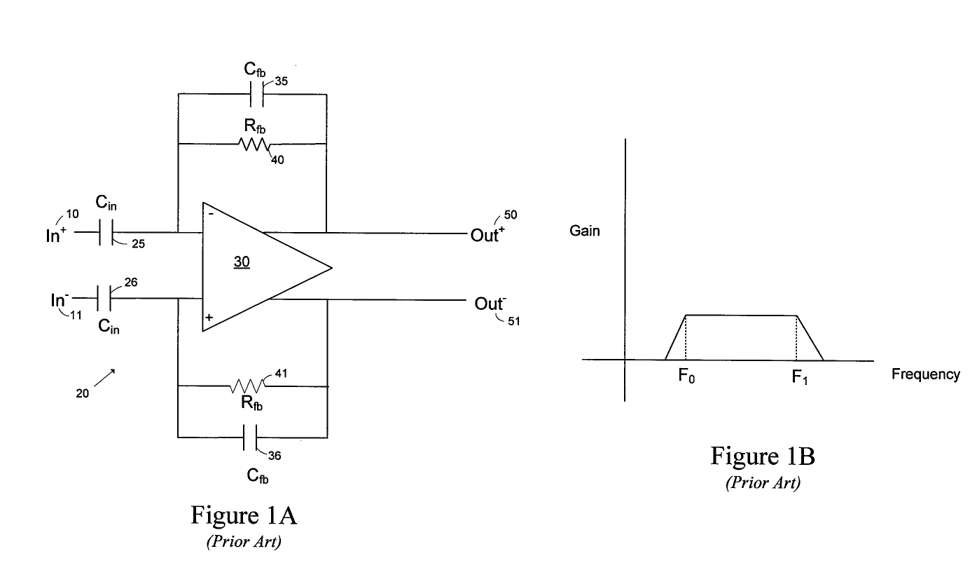

The filter 200 employs feedback connected in a different manner than the feedback described above with reference to FIG. 1. Feedback capacitor 235 is coupled between output node 253 and input node 227 of the differential amplifier. Feedback resistor 240 is coupled between an intermediate node of the resistor string 260 and the input node 227. The feedback resistor is coupled between the intermediate node 262, having a resistance R between the node 262 and the midpoint node 266, and a resistance of R(x−1) between the node 262 and the output node 253, where ‘x’ represents a total number of resistive elements of resistance R between the node 253 and the midpoint node 266. Accordingly, the voltage at the node 262 may be equal to Vₒₙ/x. By coupling the feedback resistor 240 to a node in the resistor string 260, only a portion of the voltage Vₒₙ is fed back to the input of the amplifier 230 and the input node 227.

By connecting the feedback resistor 240 between the input node 227 and an intermediate node of the resistor string 260, a smaller feedback capacitor 235 and input capacitor 225 may be used. Accordingly, the feedback capacitor 235 and input capacitor 225 are shown as having capacitance C_{fb}/x and Cᵢₙ/x, respectively, in FIG. 2. Without being bound by theory, the reduction of capacitance values can be seen by performing Kirchoff's Current Law (KCL), specifying that the sum of currents at a node will be zero, at the input node 227. Accordingly, the sum of current entering the node 227 from the feedback capacitor 235, feedback resistor 240, and input capacitor 225 will be zero. By coupling the feedback resistor 240 between the intermediate node 262 of the common mode feedback resistor string 260 and the input node 227, a reduced voltage of Vₒₙ/x is developed across the feedback resistor 240. The current through the feedback resistor may be represented as R_{fb}*V_{ON}/x. The current from the feedback capacitor having capacitance C_{fb}/x is represented as sC_{fb}/x. The current from the input capacitor having capacitance Cᵢₙ/x is represented as sCᵢₙ/x. KCL then yields an inverting transfer function for the filter 200:

$$\frac{{V}_{ON}}{{V}_{IN}} = \frac{- s {C}_{in} {R}_{fb}}{1 + s {C}_{fb} {R}_{fb}}$$

Note that the transfer function above is the same result as a corresponding analysis for a filter having capacitances C_{fb} and Cᵢₙ, but having the resistance R_{fb} coupled directly to V_{ON}. Accordingly, by coupling the feedback resistor R_{fb} to a lower voltage node (V_{ON}/x in this example), for the same feedback resistor value R_{fb}, the feedback capacitor C_{fb} may also be reduced by a factor of x while preserving an effective R_{fb}*C_{fb} time constant for the filter. Similarly, the capacitance of the input capacitor 225 may also be reduced by a factor of x, while preserving the transfer function and ratio of the input capacitance to the feedback capacitance, a ratio that is related to the gain of the filter.

In an analogous manner for feedback between a second differential input node 228 and output node 254, the capacitances of input capacitor 226 and feedback capacitor 236 coupled to a differential input node 228 may be reduced. A feedback resistor 241 is coupled between an intermediate node 264 of the common mode feedback resistor string 260. The intermediate node 264 is coupled to the midpoint node 266 by a resistance R, and to a differential output signal V_{OP} 251 by a resistance R(x−1). Accordingly, the voltage at the node 264 may be equal to V_{OP}/x.

Although the resistor string 260 of FIG. 2 is shown having four resistive elements, any number may be present, and other numbers may be used in other examples. Any elements having a resistance, including resistors of any kind, may be used to element the resistor string 260. A resistance R(x−1) between the intermediate node and the filter output may be significantly smaller than the feedback resistance R_{fb} in some examples, to reduce any adverse effects from the presence of the resistance R(x−1) on the frequency response of the filter. Although feedback is provided between inputs and outputs of a differential amplifier 230 in FIG. 2, an analogous feedback technique may be used to reduce capacitance sizes for feedback around other devices in other examples. The filter 200 of FIG. 2 is exemplary only, and other electrical components may be provided or omitted in other examples, in addition to, or between elements discussed with regard to FIG. 2. The input capacitors 225 and 226 are shown in FIG. 2 as variable capacitors to set a variable gain of the filter 200; however, in other examples, the input capacitors 225 and 226 may not be variable.

For a given resistor value, and thus resistor size, the ability to reduce the feedback capacitance, input capacitance, or both, as described above, may have a variety of advantages. Generally, for filters such as the filter 200, reducing power consumption, area, or both, of the filter is desirable in that more die may be fabricated per semiconductor wafer, yielding a cheaper product in a less expensive package. Further, lower power consumption may be desired in products where power consumption is a factor in evaluating competing designs.

Capacitive loading at the output of the amplifier 230 affects the achievable bandwidth of the filter 200. To obtain desired bandwidth performance, power may need to be increased to drive a capacitive load at the output nodes 253 and 254. By reducing the capacitance of the feedback capacitors 235 and 236, capacitive loading at the output nodes may be reduced, and less power may be required to achieve desired bandwidth of the filter 200. However, the bandwidth is also affected by the product of the feedback capacitance C_{fb} and the feedback resistance R_{fb}. The C_{fb}*R_{fb} product affects the pole and zero locations for the filter response. As described in examples above, however, capacitive loading, in terms of the capacitance of the feedback and input capacitors, may be reduced while maintaining a same effective R*C product when a feedback resistor is coupled to an intermediate node of a resistor string tied between differential amplifier outputs instead of coupling the feedback resistor directly to an output node of the differential amplifier.

Another advantage may be gained in some examples by reducing a size of the input capacitors 225 and 226 in FIG. 2. Namely, reduced input capacitances may allow smaller transistor switches to be used (transistor switches not shown in FIG. 2) in a switched-capacitor implementation. Transistor switches may also or alternatively be used to vary the capacitance Cᵢ. Smaller transistor switches may yield power savings for the filter 200.

Not all of the advantages described herein may be achieved in each example or implementation of feedback described herein. The advantages described are not intended to limit the applications or examples of filters, devices, or feedback implementations achievable. Rather, the advantages are provided to allow those skilled in the art to appreciate some of the performance variables that may be manipulated using examples described.

In some examples, disadvantages may occur. For example, input-referred offset and output-referred noise, metrics that may affect the dynamic range and fidelity of a signal receive path, may be adversely affected in some examples. However, benefits attained from advantages described may outweigh the adverse affects from input-referred offset and output-referred noise occurring when a feedback resistor is coupled to an intermediate node in a resistor string tied between differential outputs. Those skilled in the art will appreciate these design trade-offs in selecting an implementation suitable for desired performance specifications.

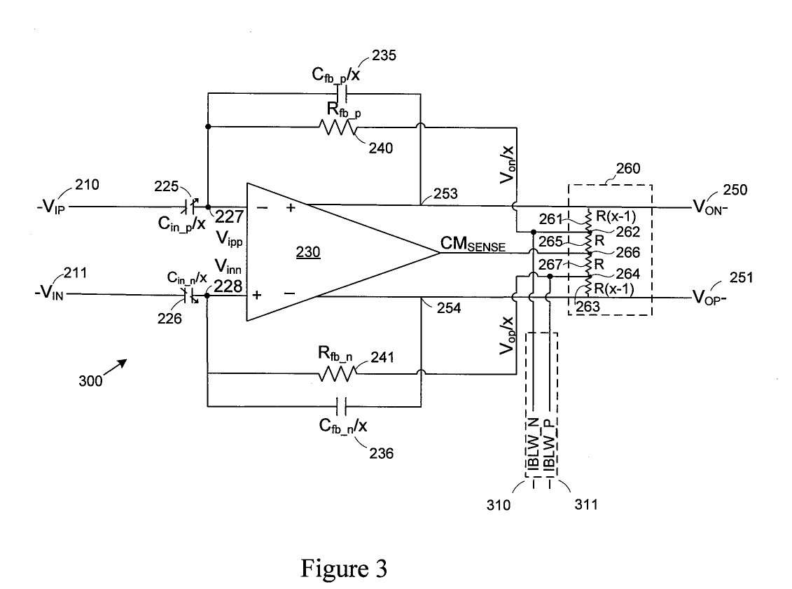

Another example of a filter 300 is shown in FIG. 3. Like elements in FIG. 3 are labeled with like reference numerals from FIG. 2, and filter operation is analogous. The filter 300, however, makes use of the resistor string 260 for an additional purpose. In particular, dynamic offset cancellation currents IBLW_N 310 and IBLW_P 311 are coupled to intermediate nodes 262 and 264 of the resistor string 260, respectively. The dynamic offset cancellation currents are generated in another circuit block (not shown in FIG. 3), such as a current digital to analog converter, and may compensate for non-idealities in the amplifier 230. Routing the dynamic offset cancellation currents 310 and 311 through at least a portion of the resistor string 260 already present for common mode feedback purposes reduces capacitive and resistive loading at the output of the amplifier 230 by eliminating or reducing the need for additional capacitive or resistive elements, or both to be provided specifically for the dynamic offset cancellation currents.

The filter 300 accordingly employs the resistor string 260 to provide common mode feedback, to provide a reduced feedback voltage to the feedback resistors 240 and 241, and to provide dynamic offset cancellation. In other examples, it should be understood that any combination of these features may be provided by the resistor string 260. In some examples, the feedback resistors 240 and 241 may be coupled to the output nodes 253 and 254, respectively, instead of intermediate nodes of the resistive string 260, and the resistive string 260 used to provide common mode feedback and dynamic offset cancellation. In this manner, some of the capacitance reductions in the feedback and input capacitances may not be achieved as described above, but output loading may be reduced by use of the resistor string 260 to provide dynamic offset cancellation.

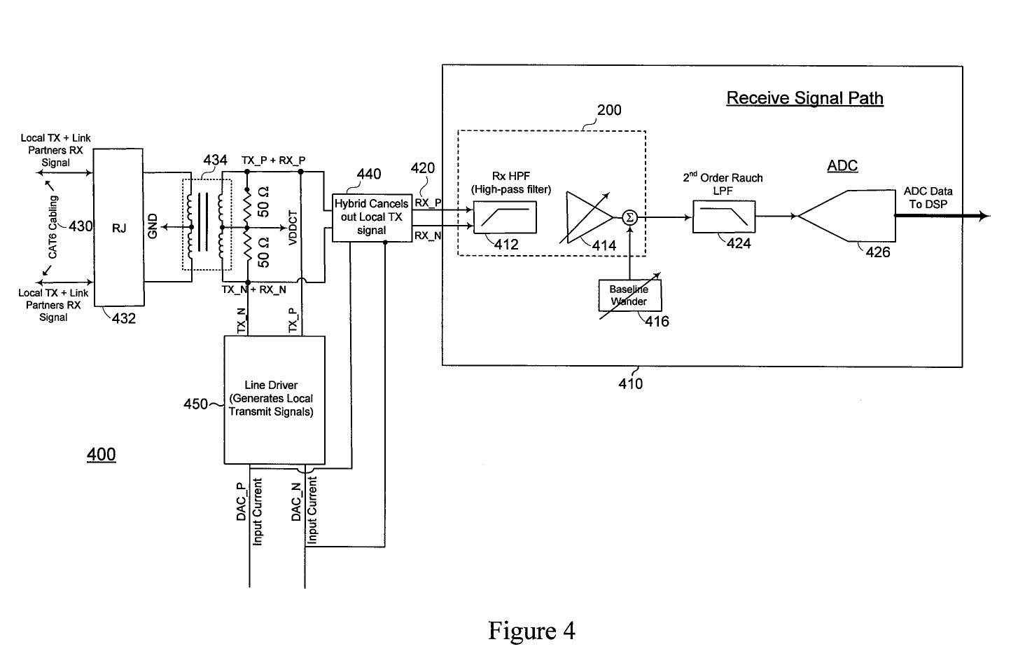

FIG. 4 is a schematic illustration of an example system 400 including a receive signal path 410. Examples of filters described above, such as the filter 200 may be used in the receive signal path of a baseband data communications system 400. The filter 200 may perform functions of high pass filter 412 and programmable gain amplifier 414, and may include dynamic offset cancellation provided by a variable baseline wander current 416. Generally, a differential receive signal 420 may be received by the filter 200, and the filtered and amplified signal may be provided to additional filter blocks, such as a low pass filter 424 to further filter noise. The filter 424 is optional, and additional or other filters may also be provided. The filtered signal is provided to an analog to digital converter 426 for conversion to a digital signal that may be provided to a digital signal processor (not shown). The general receive signal path 410 may be used to process substantially any type of received signal having any frequency properties. In some examples, the receive signal path is used in an 800 MHz clocked Ethernet system.

The system 400 shown in FIG. 4 includes additional components used to achieve full duplex operation of a transceiver. Full-duplex operation will now be described, however, in other examples, it is to be understood that receive and transmit signals may be processed using separate paths.

In full duplex operation, a locally generated transmit signal, as well as a received signal from a link partner, may be superimposed on a same physical medium, such as a CAT6 cable 430. The cable 430 is coupled to an interface 432 and a transformer 434 couples the superimposed signal onto a chip for coupling to a hybrid block 440. A line driver 450 generates the local transmit signal, and couples the local transmit signal to the transformer 434 for coupling to the interface 432. Accordingly, a superimposed signal containing both a locally generated transmit signal and a received signal, may be present at the input to the hybrid block 440. The locally generated transmit signal may generally be stronger than the received signal, which may have passed through a noisy medium, or traveled over a lossy path prior to receipt at the interface 432.

The hybrid block 440 cancels out the locally generated transmit signal from the superimposed signal at the input of the hybrid block 440. In this manner, substantially only the received signal may be applied to the receive signal path 410. The power requirements for the hybrid block 440 may be reduced through use of techniques described above that may reduce capacitance sizes and power requirements of the filter 200. That is, by reducing power requirements of the filter 200, the power consumption of the hybrid block 440 may be reduced.

The system 400 may be supplied in any of a variety of communications devices for processing received signals, transmitted signals, or both. Devices employing examples of the system 400 may include, but are not limited to, laptop computers, desktop computers, cellular telephones, and other mobile devices.

From the foregoing it will be appreciated that, although specific embodiments of the invention have been described herein for purposes of illustration, various modifications may be made without deviating from the spirit and scope of the invention.

What is claimed is:

1. A filter, comprising:
a differential amplifier including first and second differential input terminals and first and second differential output terminals;
a resistor string including a plurality of resistive elements coupled between the first and second differential output terminals, wherein the resistor string is configured to provide a common mode sense voltage, and wherein the resistor string includes an intermediate node located between the first and second differential output terminals and configured such that a voltage having a value between the voltages at the first and second differential output terminals is generated at the intermediate node;
a feedback resistor coupled between the intermediate node of the resistor string and the first differential input terminal; and
a feedback capacitor coupled between the first differential output terminal and the first differential input terminal.

2. The filter of claim 1, wherein the feedback capacitor is coupled directly to the first differential output terminal.

3. The filter of claim 1, wherein at least one resistive element is coupled between the intermediate node and the first differential output terminal.

4. The filter of claim 1, wherein the resistor string has a first resistance between the intermediate node and the first differential output terminal and a second resistance between the intermediate node and the common mode sense voltage.

5. The filter of claim 4, wherein the resistor string comprises a first number of resistive elements configured to provide the first resistance and a second number of resistive elements configured to provide the second resistance.

6. The filter of claim 1, wherein the capacitance of the feedback capacitor is based in part on a ratio between the voltage at the first differential output terminal and the voltage at the intermediate node.

7. The filter of claim 1, further comprising:
an input capacitor coupled to the first differential input terminal.

8. The filter of claim 7, wherein the capacitance of the input capacitor is based in part on a ratio between the voltage at the first differential output terminal and the voltage at the intermediate node.

9. The filter of claim 1, wherein the feedback resistor is a first feedback resistor, the feedback capacitor is a first feedback capacitor, and the intermediate node is a first intermediate node, wherein the resistor string further comprises a second intermediate node, and wherein the filter further comprises:
a second feedback resistor coupled between the second intermediate node of the resistor string and the second differential input terminal; and
a second feedback capacitor coupled between the second differential output terminal and the second differential input terminal.

10. The filter of claim 9, further comprising:
an input capacitor coupled to the second differential input terminal.

11. The filter of claim 1, wherein the intermediate node is further configured to receive a dynamic offset cancellation current.

12. The filter of claim 1, wherein the resistor string is further configured to generate the common mode sense voltage at a midpoint of the resistor string, and wherein the intermediate node is located between the midpoint and the first differential output terminal.

13. A system for baseband communications, comprising:
a filter configured to filter and amplify a receive signal to thereby generate an analog output signal, the filter including:
an amplifier having an input terminal and an output terminal;
a feedback capacitor coupled between the input terminal and the output terminal;
a voltage-generating resistor coupled to the output terminal and configured to generate a sense voltage at an intermediate node; and
a feedback resistor coupled between the intermediate node and the input terminal; and
an analog-to-digital converter configured to receive the analog output signal and generate a digital output signal.

14. The system of claim 13, further comprising:
a hybrid block configured to receive a superimposed signal including the receive signal and a transmit signal, wherein the hybrid block is further configured to substantially cancel the transmit signal and couple the receive signal to the filter.

15. The system of claim 14, further comprising:
a transformer coupled to a cable interface and configured to receive the superimposed signal and couple the superimposed signal to the hybrid block.

16. The system of claim 14, further comprising:
a line driver configured to generate the transmit signal.

17. The system of claim 14, further comprising:
a baseline wander current generator coupled to the intermediate node.

18. The system of claim 14, wherein the filter and analog-to-digital converter are configured for operation in an 800 MHz clocked Ethernet system.

19. A feedback method in a baseband communications filter having a resistor string coupled across the filter output, the method comprising:
generating a common mode sense voltage with the resistor string;
generating an intermediate voltage with the resistor string; and
feeding back a current to a filter input based on a feedback resistor and the intermediate voltage.

20. The feedback method of claim 19, wherein the baseband communications filter comprises an amplifier coupled between the filter input and the filter output, the method further comprising:
feeding back the common mode sense voltage to the amplifier.

21. The feedback method of claim 19, further comprising:
coupling a dynamic offset cancellation current to the intermediate node.

22. The feedback method of claim 19, further comprising:
feeding back a frequency-dependent current to the filter input based on a feedback capacitor coupled between the filter input and the filter output.

23. The feedback method of claim 22, wherein a capacitance of the feedback capacitor is based in part on a ratio between a voltage at the intermediate node and a voltage at the filter output.

24. A feedback method for an amplifier generating an output signal, the method comprising:
attenuating the output signal;
feeding back the attenuated output signal to an input terminal of the amplifier through a first impedance element; and
feeding back the output signal to the input terminal of the amplifier through a second impedance element, wherein the output signal being fed back through the second impedance element is less attenuated than the output signal fed back through the first impedance element.

25. The feedback method of claim 24, wherein the first impedance element comprises a resistor and the second impedance element comprises a capacitor.
